(19) United States
(12) Patent Application Publication
(10) Pub. No.: US 2009/0006256 A1
(43) Pub. Date: Jan. 1, 2009

(54) Peer to Peer File Sharing Mobile System with Copyright Protection

(75) Inventors: Alexander Lazovsky, Petah-Tikva (IL); Alexander Zaidelson, Rehovot (IL); Jhanna Lazovsky, Petah-Tikva (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: NETBARRAGE LTD., Petach Tikvah (IL)

(21) Appl. No.: 12/159,660

(22) PCT Filed: Jan. 18, 2007
(86) PCT No.: PCT/IL07/00066

§ 371 Date: Aug. 14, 2008

(30) Foreign Application Priority Data
Jan. 19, 2006 (IL) 173268

(51) Int. Cl. H04L 9/00; G06Q 30/00

(52) U.S. Cl. 705/57; 705/26

(57) ABSTRACT

The present invention relates a peer to peer system for enabling a mobile device user to legally search and only legally download content items by his mobile device, comprising: (a) a user software having a user interface at the mobile device for connecting to a peer to peer network, searching for a content item according to a user query, introducing the results to the user, and enabling a conditional downloading only upon ensuring payment for items that are found to be copyright protected; (b) an identification server for receiving identification information relating to a selected right protected item from said user software, searching for at least meta data and price corresponding to said item, and forwarding the found meta data and price to the user software; (c) a module within said user software for, upon receipt of said meta data and price, suspending the conditional downloading, prompting the user to appropriately pay at a billing server if the item is copyright protected, and resuming the download only upon clearing said payment; and (d) billing server for receiving payment from the user, and upon completion of same, sending payment clearance to said user software, which in turn resumes downloading of the item.

### FIELD OF THE INVENTION

The field of the invention generally relates to internet features of mobile devices, such as mobile telephones. More particularly, the invention relates to a peer to peer file sharing mobile system having copyright protection. By “mobile peer to peer system” it is meant to a system in which at least one of the connected devices is mobile.

### BACKGROUND OF THE INVENTION

The recent generations of the mobile telephones include advanced Internet capabilities, and also have a large memory storage, and a capability of playing multi media files, such as music (for example MP3 format) or video (for example, MPEG format). Therefore, many capabilities which were limited before to stationary computers, have become available in the mobile telephones. Hereinafter, although reference is made to mobile telephones, it should be noted that the invention can be carried out in any mobile device having Internet and multi media capabilities, such as portable music players, portable game consoles, etc.

One very popular feature that was limited before, generally to stationary computers, is the capability of peer to peer file sharing. Two such known applications are the Napster, and Kazaa. However, such applications have faced a significant legal problem of enabling piracy and copyright violation. Following this situation, some newer generation applications have been developed, which try to enforce copyrights by inspecting all the downloaded contents. If the content is identified as copyright protected, the download is either eliminated, or the user is prompted to pay for the content as condition for the downloading. Some of said systems apply Robust Audio Fingerprinting on the downloaded content for said verification. However, such said copyright protecting peer to peer file sharing systems have, until now, been limited to personal computers, and not to mobile devices of the group stated above.

Some new peer to peer file sharing applications have also been recently developed for mobile devices by the open source community, for example Mopiphant. However, in similarity to the cases of Napster and Kazaa, such mobile applications are expected to face legal problems for enabling piracy. In this respect, such prior art mobile applications do not have capabilities of inspecting the content in order to prevent copyright violations, and they do not enable paying for the downloaded content. Furthermore, such applications do not enable the user to access and purchase content from a centralized catalogue besides the file sharing network. Moreover, such applications do not enable a user to access a specific content, unless he submits at least one keyword relating to the content, such as the artist, name of the content, the author, etc. For example, if the user has a portion of unfamiliar music which he heard and recorded, in said applications he cannot use this unfamiliar portion in order to obtain the full content. This is particularly important in mobile devices where the user is out, and he may hear music that is played by a third party, such as a radio, in a bar, club, etc.

It is therefore an object of the present invention to provide a peer to peer file sharing mobile system with copyright protection.

It is still another object of the present invention to prevent piracy resulting from file sharing in mobile systems.

It is still another object of the present invention to enable mobile consumers to select downloading of items from either a master catalogue or from open peer to peer networks, or simultaneously from both, while still enforcing copyrights.

It is still an object of the present invention to enable a mobile user to purchase a full content he is unfamiliar with, by submitting a recorded portion of said content.

It still another object of the present invention to provide content owner with a way of enforcing copyright and receiving royalties in mobile peer to peer file sharing networks.

### SUMMARY OF THE INVENTION

The present invention relates to a peer to peer system for enabling a mobile device user to search and legally download content items by mobile his device, which comprises: (a) a user software having a user interface at the mobile device for connecting to a peer to peer network, searching for a content item according to a user query, introducing the results to the user, and enabling a conditional downloading only upon ensuring payment for items that are found to be copyright protected; (b) an identification server for receiving identification information relating to a selected right protected item from said user software, searching for at least meta data and price corresponding to said item, and forwarding the found meta data and price to the user software; (c) a module within said user software for, upon receipt of said meta data and price, suspending the conditional downloading, prompting the user to appropriately pay at a billing server if the item is copyright protected, and resuming the download only upon clearing said payment; (d) a billing server for receiving payment from the user, and upon completion of same, sending payment clearance to said user software, which in turn resumes downloading of the item.

Preferably, the identification information is selected from the group which comprises a hash code, an acoustic fingerprint of the content, the name of the content, a portion of the content, or any other data specific only to the downloaded content.

Preferably, the meta data comprises alphanumeric data for identifying the item.

Preferably, in addition to said meta data and price, the identification server forwards to the user software usage rules.

Preferably, the usage rules include the conditions for using the item, which are granted to the user upon payment of the price.

Preferably, the system further comprises a content server associated with said identification server, for enabling direct downloading of items from the content server to the user mobile device.

Preferably, the content items that are directly downloaded from the content server are protected by a Digital Rights Management-DRM technique.

Preferably, the system further comprises a mediating proxy server between the mobile device and the peer to peer network, for enabling the user mobile device to higher usage priority while using the peer to peer network.

Preferably, the mobile device and the user software have a recording capability, enabling the user to record a piece of music or a portion thereof, and to submit the same to the identification server as identification information.

Preferably, the mobile device and the user software have a speech capability, enabling the user to submit a speech relating to a searched item, which is forwarded to a speech recognition server, which in turn returns a string or meta data which is submitted as a query for locating a searched item in the peer to peer network.

### BRIEF DESCRIPTION OF THE DRAWINGS

In the drawings:

FIG. 1 shows the general structure of the peer to peer mobile system according to one embodiment of the present invention;

FIG. 2 shows a general structure of the system according to a second embodiment of the present invention, which includes a speech recognition feature;

FIG. 3 shows still another embodiment of the peer to peer mobile device system of the present invention, which comprises at least one peer to peer proxy server; and

FIGS. 4a to 4d show various screens of the mobile device user interface, according to embodiments of the invention.

### DETAILED DESCRIPTION OF PREFERRED EMBODIMENTS

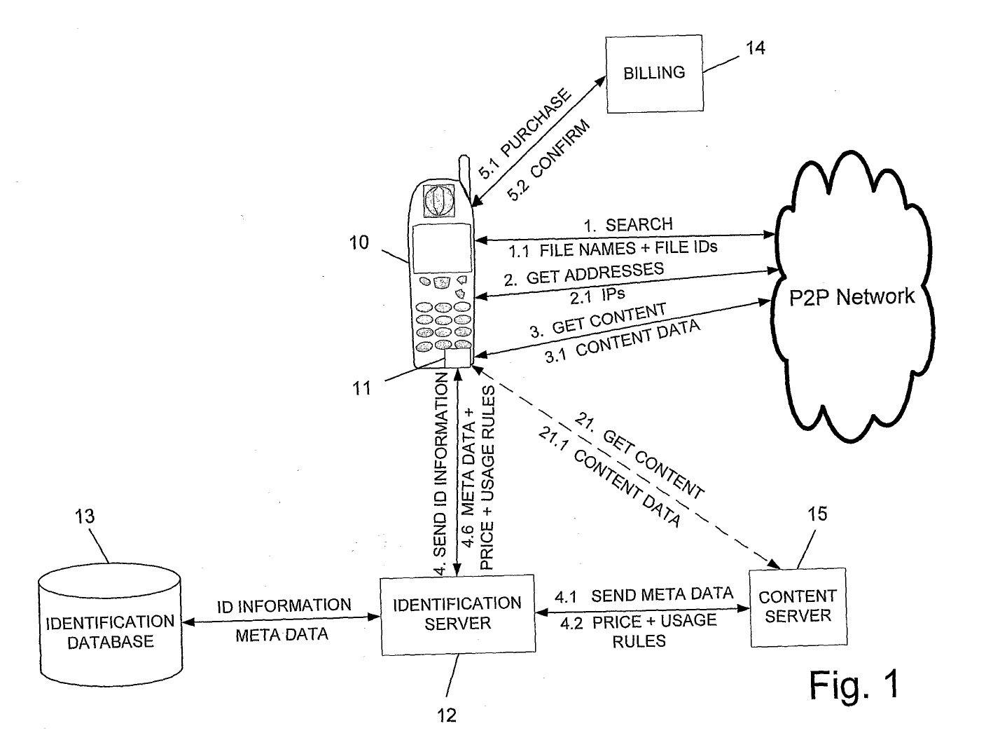

FIG. 1 illustrates in a block diagram form the general structure of the peer to peer file sharing system according to a first embodiment of the present invention. The mobile device 10 has sufficient Internet capabilities, generally has sufficient memory storage, and it is equipped with a peer to peer file sharing software 11 (hereinafter referred to as “the client software”). In order to obtain a content item, the user submits a query to software 11. Following this query, a peer to peer search 1 is conducted, followed by a list 1.1 of file names (content names) matching the query keyword/s. In some cases, depending on the specific peer to peer network, the response from the peer to peer network includes the list of IP addresses where each content item can be accessed. In other cases, an additional request “Get addresses” 2 may be initiated separately. Anyhow, in both of said cases, a content item on the list is associated with one or more Internet (IP) addresses 2.1 from which said content can be downloaded. Having reviewed the list of said items the user continues by selecting an item for downloading. Upon submitting said item, the procedure continues by the steps 3 and 3.1 of requesting and receiving the selected item's data. This can be done from one or more nodes of the peer to peer network, associated with said one or more IP addresses. Upon receiving sufficient information enabling identifying the content being downloaded (hereinafter “identifying information”), the software 11 suspends the transfer and submits this identifying information to an identification server 12. The identification information may be any piece of data which is specific to the content being downloaded. For example, the identification information may be a hash code, an acoustic fingerprint of the content, the name of the content, a portion of the content, or any other data specific only to the downloaded content. The identification server receives said identification information, looks it up in its identification database 13 in order to find content item meta data corresponding to the identification information 4. Such meta data may include the item title, author name, associated graphics, etc. If the meta data corresponding to the identification information is found by the identification server 12, the identification server issues a request 4.1 to the content server to retrieve the usage rules associated with the identified content item. Such usage rules may include the item's price, the rights that are granted to the user upon purchasing the item, such as the right to copy the content to other devices, play it one or more times, and so on. The usage rules 4.2 are returned to the identification server which subsequently returns the meta data and the usage rules 4.6 to the software 10. Upon receiving the meta data and the usage rules, the client software 11 prompts the user to purchase the content. If the user agrees to purchase the content item, a billing procedure 5.1 and 5.2 is performed against billing server 14. Upon completion of the billing procedure, a confirmation 5.2 is provided to the software 11 of the mobile telephone. Said confirmation serves as a signal to software 11 to enable continuation of the item downloading.

In a variant of the present invention, the operation of the system operates in a subscription basis, where the user pays for a plurality of copyright protected items, and where the downloading confirmation 5.2 by the billing server is sent automatically for as long as the pre-payment remainder covers the price of the current downloaded item.

In yet another variant of the present invention, the operation of the system operates in a subscription basis, whereas the user pays a fixed monthly fee for unlimited downloads of copyright protected items, and where the downloading confirmation 5.2 by the billing server is sent automatically, for as long as the user has paid the periodical payment for the running period. In this variant, the subscription fees collected from the users are distributed between the copyright holders according to the number of downloads generated by their content.

The above description of FIG. 1 generally explains the manner of operation of the system of the present invention.

The system of the present invention may include a content server 15 that hosts a content catalogue. In some cases, upon approval of the purchase, the system may not transfer the content to the user via the peer to peer network, but alternatively it may initiate a new download of the selected item from the content server 15 to ensure the user the supply of a high quality and verified content, when available at the content server. In that case, the supplied content may be preferably usage protected by means of a Digital Right Management (DRM) technique known in the art.

The system may also include a recommendation engine that suggests content items to the user based on his previous behavior. Such behavior may include content purchases, his peer to peer searches etc.

The system of the present invention may optionally include an on the air music recognition and ordering sub-system. For such feature, the telephone should include a sound recording capability. In that case, the user records a piece of music or a portion thereof. Said piece or portion is thereafter submitted to the identification server. The identification server applies recognition algorithms to identify the piece. Upon successful identification, the meta data of the item is returned to software 11, which prompts the user to purchase the item. Alternatively, the user is allowed to use the meta data in order to carry out a query in the peer to peer network, as described before.

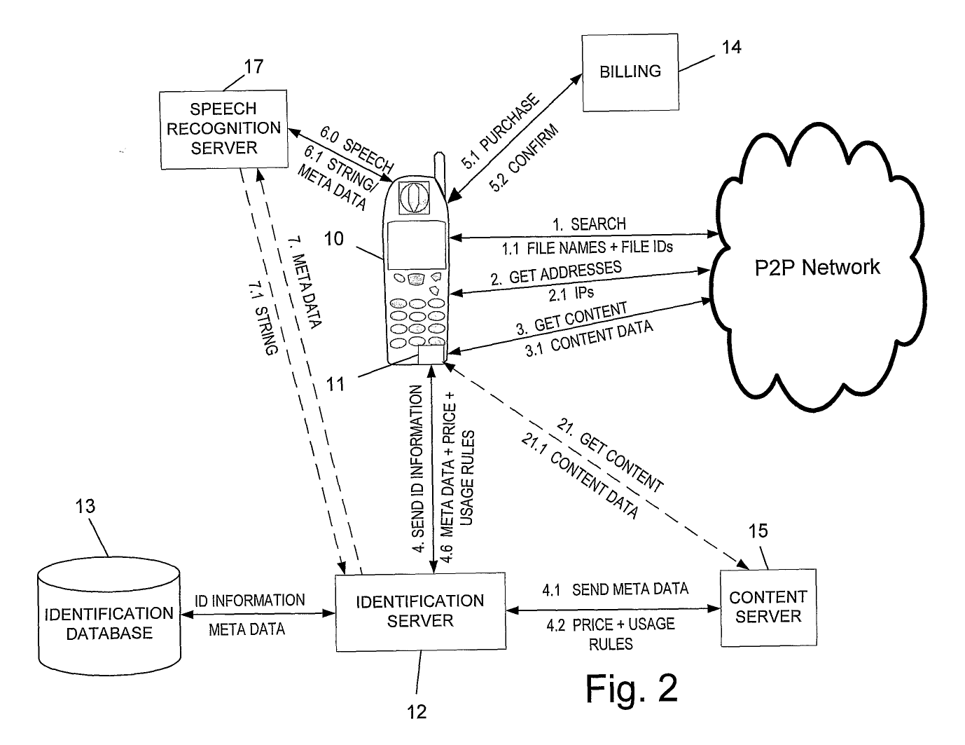

The system of the present invention may optionally include a speech recognition engine that facilitates the process of entering search keywords into the software 11 by the user. For such feature, the telephone should include a sound recording capability. FIG. 2 shows the system with speech recognition engine. The software 11 allows the user to articulate the phrase that identifies the desired content, or content category or content attribute including but not limited to content author and/or content title. The recording of the user's speech 6.0 is sent to the Speech Recognition Server 17 which returns the string representation 6.1 of the said speech phrase, Optionally, the speech recognition server may, upon successful recognition of the phrase uttered by the user, issue a request 7.1 to the identification server, using the string representation of the user's speech as identifying information. The identification server searches the identification database to retrieve the metadata associated with the string 7.1, and such metadata is subsequently returned back to software 11. The software may prompt the user to purchase the content. Alternatively, the user is allowed to use the meta data or the recognized string in order to carry out a query in the peer to peer network, as described before.

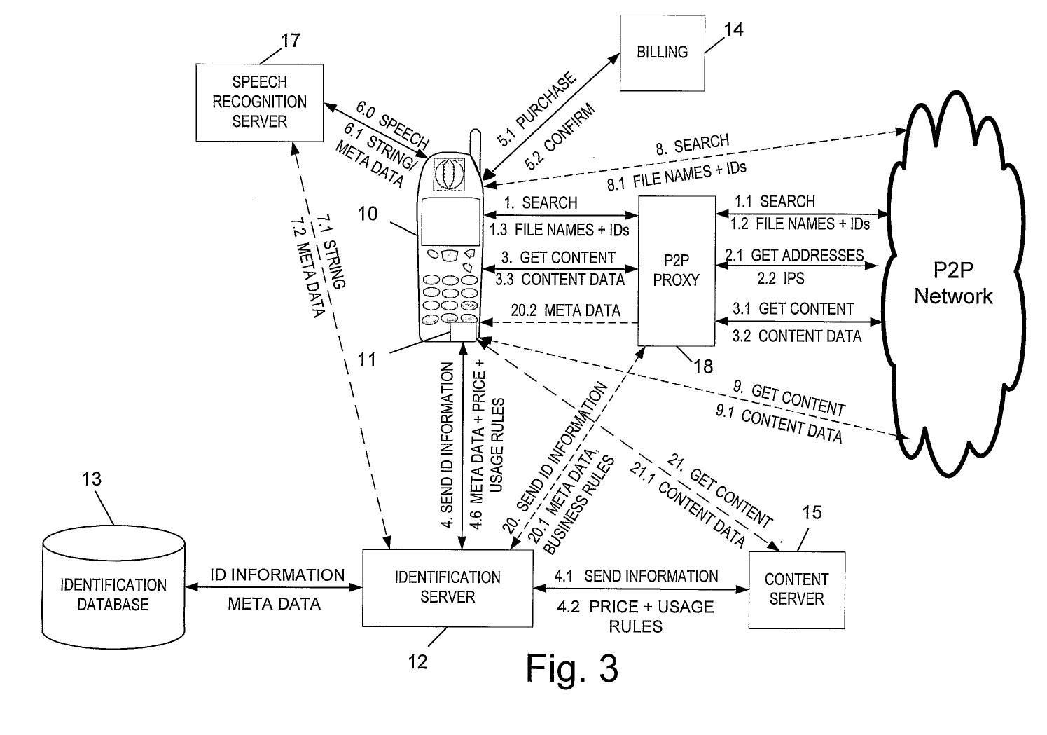

Generally in cellular networks, the end devices do not receive a dedicated IP address. As a result, it is generally impossible to initiate IP based communication with such devices from the outside. A general rule, in many existing peer to peer file sharing networks, dictates that clients that cannot be directly connected to by others, for example clients that reside in a NAT (Network Address Translation) environment, receive low priority which results in much slower downloads for such clients. As a result, the end devices of the systems of FIGS. 1 and 2 may experience slow downloading times for files that are downloaded from certain peer to peer networks. The system of FIG. 3 addresses this issue. In addition to the components previously discussed in reference to FIGS. 1 and 2, the system comprises at least one computer connected to the Internet and to the one or more peer to peer networks. Said computer acts as a proxy for one or more end devices, and performs searches in and downloads from said peer to peer networks on their behalf. In the system of FIG. 3, the software 11, following a command by the user, issues a query (search) 1 that includes one or more keywords to the proxy 18, which in turn issues query 1.1 to the peer-to-peer network. The query results 1.2 that may include file names, file IDs and file identifiers such as file hashes, are returned from the peer-to-peer network to the proxy, which in turn forwards them to the mobile device in a message 1.3.

Having reviewed the list of returned files, the user chooses one or more files that he desires to download, and software 11 sends Get Content request 3 to the proxy. The Get Content request includes one or more file identifiers. Upon receiving the Get Content request, the proxy initiates the process of downloading content from the peer-to-peer network. Said process may, depending on the specific peer-to-peer protocol used, include the Get Addresses request 2.1 issued by the proxy, in response to which the network returns the list of IP addresses 2.2 corresponding to network nodes from which the said content item can be downloaded. Further, the proxy 18 issues a Get Content request 3.1 to one or more nodes in the peer-to-peer network, and said nodes start transferring the content 3.2 to the proxy. Upon receiving portions of content, the proxy sends the content data 3.3 back to the mobile device. When a portion of the content that allows extracting the identification information is received by the mobile device 10, the software 11 issues the Send ID Information request 4 to the Identification server, and thereafter the system acts as in the embodiments of FIGS. 1 and 2 discussed above.

As a variant of system in FIG. 3, the software 11 may issue a search request 8 directly to the peer-to-peer network rather than through the proxy, subsequently issuing the Get Content request 3 to the proxy and receiving the data from the proxy as described above.

As a variant of system in FIG. 3, the software 11 may issue both Get Content request 3 to the proxy and Get Content request 9 to the peer-to-peer network directly. In that case, the software will receive parts of content data 3.3 from the proxy and other parts of the content data 9.1 from the peer-to-peer network, simultaneously, thus increasing the efficiency of the system.

As still another variant of system of FIG. 3, the identification request 20 may be issued by proxy 18 rather than by software 11 on the mobile device, as in system on FIGS. 1 and 2. Such solution can improve performance, especially where the process of extracting the identification information is computationally intensive and the mobile device 10 has limited computing power. When proxy 18 downloads a file on behalf of the mobile device, and a sufficient part of the content is downloaded, the proxy issues an identification request 20 to the Identification Server 12. Upon receiving the meta data and the usage rules 20.1 from the Identification Server, the proxy suspends the download, and passes the meta data and usage rules to the software 11 by message 20.2. The software then operates in the same manner as described in the system of FIG. 2.

As still an additional variant of the system in FIG. 3, the system can include the Speech Recognition Server that can be used for speech-assisted search, as described in system of FIG. 2.

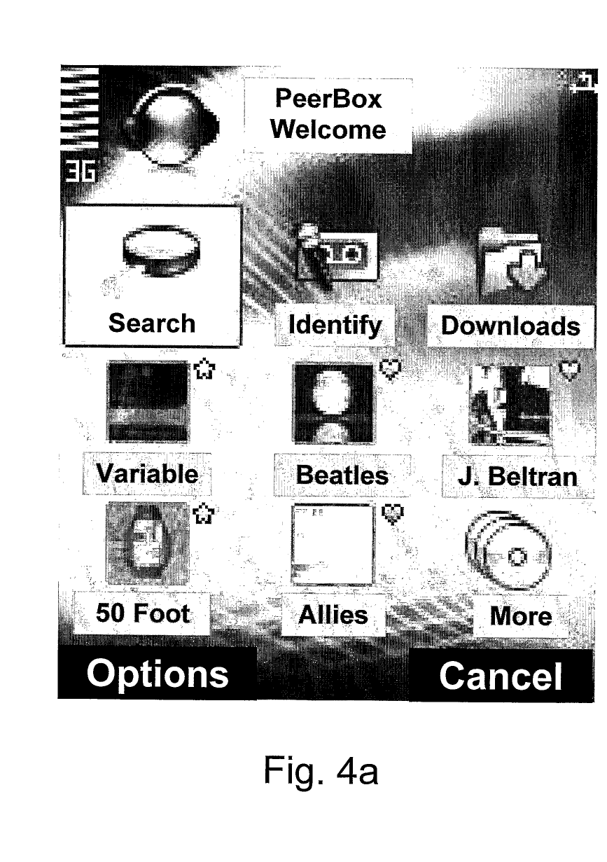

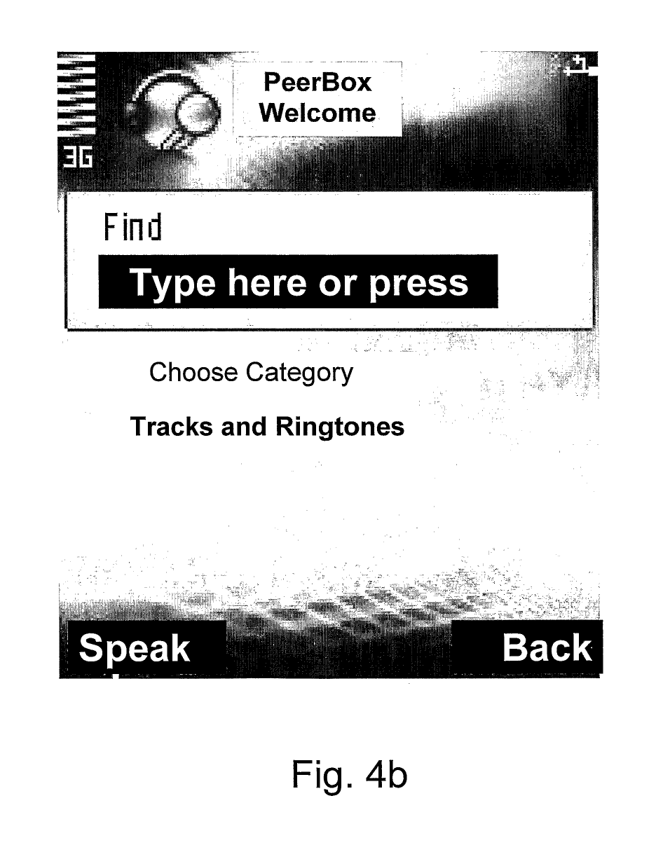

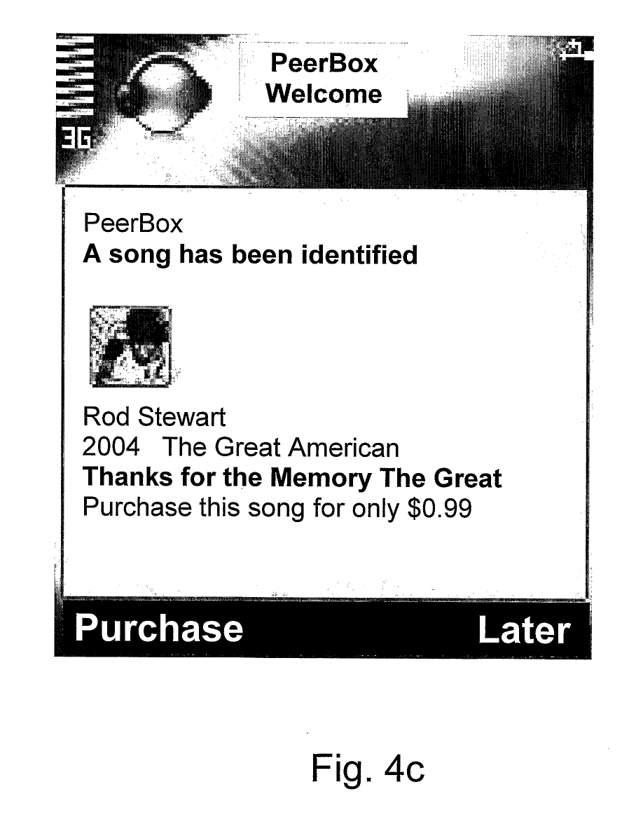

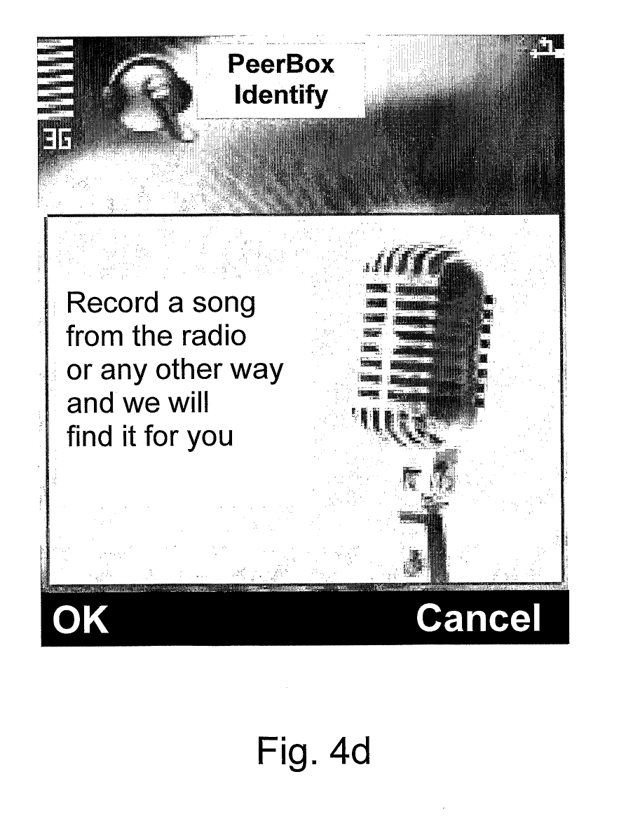

FIGS. 4a-4d illustrate the mobile telephone user interface according to one embodiment of the present invention. FIG. 4a shows the main screen of the user interface of software 11. The screen shows the action buttons and a list of content items suggested by the optional recommendation engine, and items selected by the content editor. FIG. 4b shows the application search screen with the optional speech recognition. Pushing the speak button invokes the speech recognition feature. FIG. 4c shows the prompt for purchase of a file that has been identified. The screen shows the relevant meta data for the content item, and the price. The content transfer is suspended until the user confirms the purchase, and the payment is cleared. Finally, FIG. 4d shows the song identification screen, prompting the user to record a piece of music or a part thereof, which thereafter is submitted to the identification server 13 which subsequently returns the meta data enabling the software 11 to offer the item for sale.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A peer to peer system for enabling a mobile device user to search and legally download copyright protected content items by his mobile device, comprising:
a. a user software having a user interface at the mobile device for connecting to a peer to peer network, searching for a content item according to a user query, introducing the results to the user, and enabling a conditional downloading only upon ensuring payment for items that are found to be copyright protected;
b. an identification server for receiving identification information relating to a selected right protected item from said user software, searching for at least meta data and price corresponding to said item, and forwarding the found meta data and price to the user software;
c. a module within said user software for, upon receipt of said meta data and price, suspending the conditional downloading, prompting the user to appropriately pay at a billing server if the item is copyright protected, and resuming the download only upon receiving payment clearance for said payment from said billing server; and
d. a billing server for receiving payment from the user, and upon completion of same, sending payment clearance to said user software, which in turn resumes downloading of the item.

2. System according to claim 1, wherein the identification information is selected from the group which comprises a hash code, an acoustic fingerprint of the content, the name of the content, a portion of the content, or any other data specific only to the downloaded content.

3. System according to claim 1, wherein the meta data comprises alphanumeric data for identifying the item.

4. System according to claim 1, wherein in addition to said meta data and price, the identification server forwards to the user software usage rules.

5. System according to claim 4, wherein the usage rules include the conditions for using the item, which are granted to the user upon payment of the price.

6. System according to claim 1, further comprising a content server associated with said identification server, for enabling direct downloading of items from the content server to the user mobile device.

7. System according to claim 6, wherein the content items that are directly downloaded from the content server are protected by a Digital Rights Management-DRM technique.

8. System according to claim 1, further comprising a mediating proxy server between the mobile device and the peer to peer network, for enabling the user mobile device to higher usage priority while using the peer to peer network.

9. System according to claim 1, wherein the mobile device and the user software have a recording capability, enabling the user to record a piece of music or a portion thereof, and to submit the same to the identification server as identification information.

10. System according to claim 1, wherein the mobile device and the user software have a speech capability, enabling the user to submit a speech relating to a searched item, which is forwarded to a speech recognition server, which in turn returns a string or meta data which is submitted as a query for locating a searched item in the peer to peer network.

11. System according to claim 1, wherein said payment is made on a pre-payment basis for a plurality of items, and wherein said clearance is sent from the billing server to the user software automatically as long as the pre-payment remainder covers the copyright protected price of the presently downloaded item.

12. System according to claim 1, wherein said payment is made on a periodical basis for downloading an unlimited number of copyright protected items, and wherein said clearance is sent from the billing server to the user software automatically as long as the user has paid the periodical payment for the running period and wherein the subscription fees collected from the users are distributed between the copyright holders according to the number of downloads generated by their content.
